(19) United States
(12) Patent Application Publication
(10) Pub. No.: US 2009/0124311 A1
(43) Pub. Date: May 14, 2009

(54) METHOD FOR PLAYING A GAME

(76) Inventor: Lars Zibet Sandberg, Bandhagen (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 12/266,619

(22) Filed: Nov. 7, 2008

Related U.S. Application Data
(60) Provisional application No. 60/986,302, filed on Nov. 8, 2007.

(51) Int. Cl. A63F 9/24; A63F 13/00

(52) U.S. Cl. 463/9

(57) ABSTRACT

The method is for solving a digital crossword puzzle. A first time is allocated to the first player and a second time to the second player. The first player activates a first timer to solve a first question of the crossword puzzle. The first player correctly adds a first word to the crossword puzzle. The puzzle confirms (48) the first word being correct. The puzzle adds points to a score board (51) of the first player (16). The second player (18) activates a second time (45) to solve a second word of the crossword puzzle.

### TECHNICAL FIELD

The method relates to a method for playing a game such as a crossword puzzle.

### BACKGROUND OF INVENTION

Crossword puzzles have been used for generations. However, solving conventional crossword puzzles have often been a solitary activity or in cooperation with others. Many users of crossword puzzles desire more exciting crossword puzzles wherein there the crossword puzzles are-solved in competition against others and even under time pressure. There is a need for more exciting crossword puzzle games.

### SUMMARY OF INVENTION

The method of the present invention provides a solution to the above-outlined problems. More particularly, the method is for solving a digital crossword puzzle. A first time is allocated to the first player and a second time to the second player. The first player activates a first timer to solve a first question of the crossword puzzle. The first player correctly adds a first word to the crossword puzzle. The puzzle confirms the first word being correct. The puzzle adds points to a score board of the first player. The second player activates a second time to solve a second word of the crossword puzzle. When the puzzle is finished, all the remaining unsolved words are automatically filled in.

### BRIEF DESCRIPTION OF DRAWINGS

FIG. 1 is a schematic view of a crossword puzzle of the present invention, and

FIG. 2 is a block view of steps used in the crossword puzzle of the present invention.

### DETAILED DESCRIPTION

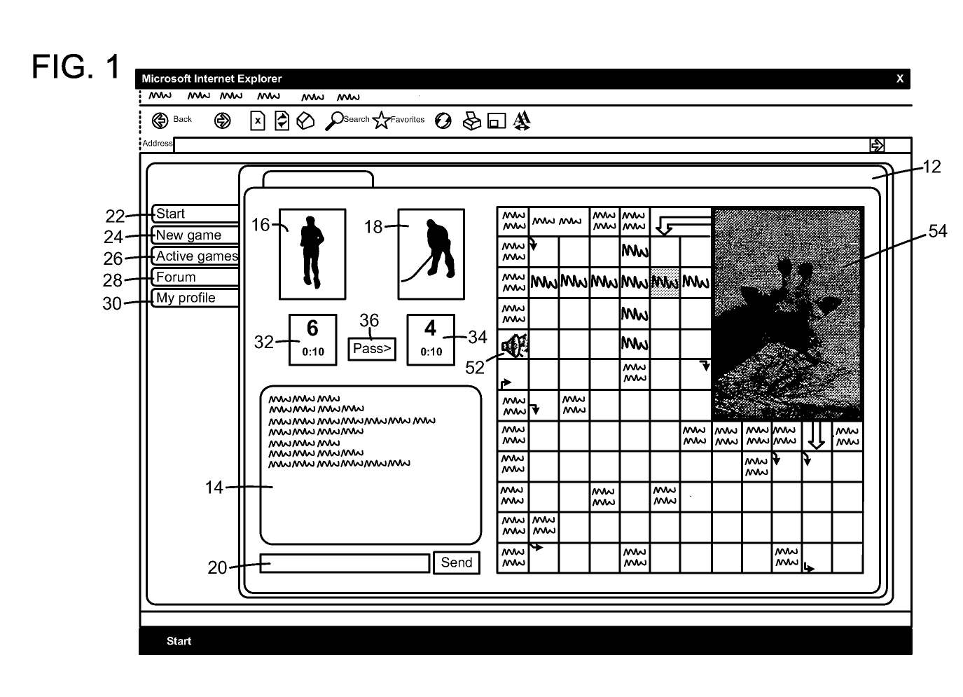

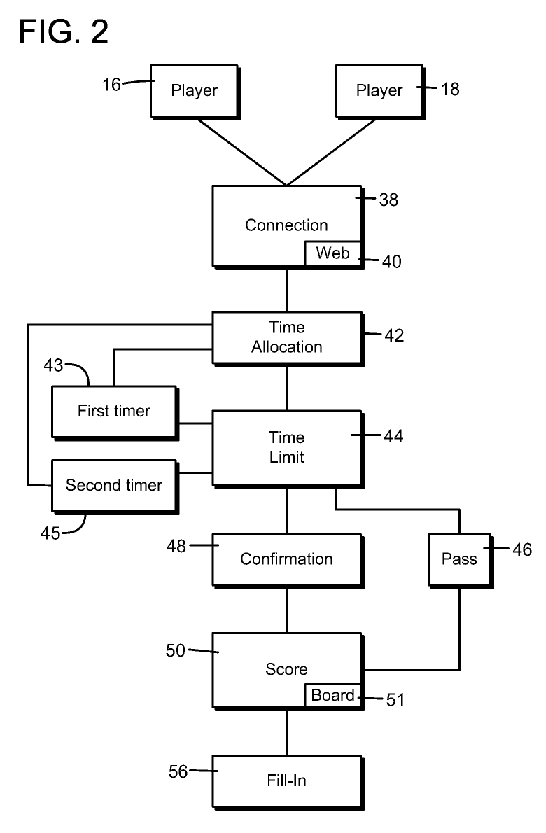

With reference to FIGS. 1-2, the digital crossword puzzle 10 of the present invention has a crossword display 12 with questions and space for answers similar to conventional crossword puzzles. Preferably, the puzzle 10 is web-based and available on-line. The puzzle 10 also has a game chat-box 14 that displays the current status of the games between a first player 16 and a second player 18. A send-box 20 may be used to send messages from one player to the other player to be displayed in box 14. The puzzle 10 may also have activity segments to start 22, activate a new game 24, list of active games 26, forum 28 and player profile 30. The puzzle 10 may include a timer that shows the time used and time available 32 for the first player 16 and the time used and time available 34 for the second player 18. If a player cannot answer any of the available questions, the player may press a pass button 36.

In operation, both players 16, 18 are, preferably, connected in a connection step 38 to a website 40 to gain access to the puzzle 10. A total time allocation 42 of, for example, 30 minutes may be given to each player. The first player 16 activates a first timer 43 and fills in a word into the display 12 within a time limit 44 such as 90 seconds. It may be possible for the first player 16 to fill in more than one word during the time limit 44. Optionally, the turn goes to the second player and the remaining time for the first player is saved for future turns. If the first player 16 cannot fill in any words, the first player 16 may either wait until the time limit 44 expires or press the pass button 36 to save on the time allocation allocated to the first player.

When a word is correctly filled in, the puzzle 10 confirms this in a confirmation step 48, by, for example, changing the background color to green. The correct word is then displayed to both players. If an incorrect word has been filled in, the puzzle may change the color to, for example, red. However, the incorrect word is not shown to the opposing player. Only correct words that have been confirmed are shown to both players.

Each letter in a correct word may be worth one point so that long words are worth more points that short words. It is also possible to allocate more points to certain questions because the questions are more difficult. The puzzle adds up the points in a scoring-step 50 to a scoreboard 51 so that each player may see how many points the players have.

If the word that is filled-in is incorrect but individual letters are correct and in the correct box then the player receives points for these. More points can be received if the player enters a correct word without help letters, meaning that the player is being helped by previously entered words. The letters can as in scrabble have different values.

The turn then goes to the second player 18 who activates a second timer 45 and fills in a word within the time limit. If the word is correct the puzzle will confirm and add points to the scoreboard 51. If the word is incorrect the background switches to red and no points are added to the scoreboard 51.

The display 12 may be of a multimedia model so that certain squares may play a sound bite 52 or a video clip 54 that requires a correct answer. The squares 52; 54 may include commercials paid for by sponsors. The squares 52, 54 may require each player to recognize or figure out the word sought after which may, for example, be the name of the sponsor or the trademark of the product/service. The sound bit or video clip is only played for the active player and the opposite player cannot hear the sound or view the video.

An important feature of the puzzle 10 is that each player 16, 18 can only play the puzzle 10 once. The puzzle 10 keeps track of which player has played the puzzle before and will prevent the same player to play the same puzzle twice against other players. Another important feature is that when the time allocated is up and the puzzle is over, all the remaining words that have not been correctly filled are automatically added in a fill-in step 56. Preferably, the game shall have support from a dictionary or encyclopedia so that if a word is clicked the player can receive an explanation of the word.

It may also be possible to separate the questions into several subject matter categories so that the puzzle is first focused on, for example, sports, and later to other subject matters once the first subject matter has been answered correctly by one of the players. More particularly, the puzzle may include questions or queries related to a selected subject matter. For example, the word sought after may extend horizontally or vertically in the crossword puzzle. When the player does not know the word sought after the player may try to solve additional questions and tasks to aid or guide the player to solve the horizontal word. More particularly, the puzzle may also include additional transport or add-on questions or tasks so that the response words extend vertically or horizontally across the squares for the incomplete horizontal word. The vertical or horizontal transport questions give no points but aid the players to solve the horizontal word that gives points. It should be understood that both the transport questions and the point providing subject matter questions may be both vertical and horizontal. After one player has either answered a vertical question correctly or not, the turn then goes to the second player. Optionally, a player may continue answering as long as the player adds correct words. The player who first comes up with the correct horizontal word is awarded the points. The additional or transport questions may thus aid a player that is completely novice in the subject matter to actually solve the horizontal word. The subject matter version may require the players to get at least one word correct in each subject matter in order to win the entire crossword puzzle.

In operation, two or more players have each been allocated a maximum time to play such as 20 minutes or any other suitable time limit. The available time may be divided into segments such as 90 seconds. When it is the turn of a player, the player may try to solve as many words as possible anywhere in the crossword puzzle. When an incorrect word has been entered, the background color changes to, for example, a red color. The incorrect word may either be automatically erased or erased by activating a reset button located at a lower end of the puzzle display. As soon as the player has filled in a correct word a sound may be heard and the background color changes to, for example, a green color. The correctly filled in word is, at the same time, made visible for the opponent and the turn automatically goes to the other opposing player. If a player cannot come up with any word during the 90 seconds, the turn goes automatically over to the other player. A player may, when it is the player's turn, at any time press a pass function when the player cannot come up with any suitable word. This is important since the time factor is of great importance in the crossword puzzle of the present invention since the amount of time used by each player, when the game is over, is, preferably, included in the overall points. This means that a player who has filled in fewer words can win anyway by having used up less time when the game is over. This also mean that it is possible to play strategically with the time factor by choosing to quickly fill in easy and short words first instead of longer and more point generating words. When the available time is up for a first player and the other player has time left the first player may choose to continue playing by using negative time. As indicated above, the puzzle game of the present invention may include special film and sound squares that are intended for commercial messages and questions related thereto. The answers to these questions may be particularly point generating. Sound illustrations do not always have to consist of advertisement, but can also include a famous voice, animal sounds or something similar that the player shall identify. When the crossword puzzle is over, such as when the time is up for all players, all words that have not been filled in will automatically be filled in. A player is only permitted to play the same crossword puzzle once and the program keeps track of which player has played with crossword puzzles.

One variation of this game is that the timer always goes to a set time such as 90 seconds so that the player may fill in as many words as possible during this set time interval before the turn goes over to the other player.

Another variation is that all the players, such as two or more players, have continuous access to the crossword puzzle during the entire game and the player that is first to fill in a word gets the points for this word.

It is also possible to use a criss-cross version which includes a game display in a square pattern where certain squares are numbered and other, in a continuous sequence, are completely black. The numbered questions that are answered in the corresponding numbers on the game display are placed in two columns of which one is for vertically directed questions and one is for horizontally directed questions, at the side thereof.

Preferably, there may exist an option to play an alternative “criss-cross” version (such as a traditional crossword) in the game, meaning a board with only black and white squares that shall be played in the following way. When two players challenge each other in a duel the look of the board referred to above will be randomly generated, alternatively collected from a database consisting of different boards with only black and white squares. Thereafter the game is played in the same way as the basic game, meaning that the players in turns and within a limited time for example 15 min each, fill out the rows or alternatively fill out as much as the players can manage within for example 90 seconds. Only words that exist in the country's dictionary will preferably be accepted. Long words yield more points than short (one point per letter). The players are allowed to pass your turn if the players cannot write anything. After player 1 has filled in a word and player 2 shall write a word, then this word must be in connection with the word that player one has filled in, meaning that it must by some letter be connected to this word. If player 2 is not able to write a word in connection, then he may write it anywhere on the board but will only receive a total of one point for such a word regardless of its length.

In this way the players are preferably always allowed to write a word anywhere on the board as this will progressively make the game harder when more of the board is filled. The players play until all white boxes are filled. If white boxes remain unfilled when the game is over, the winner is the player that has until then collected most points.

It is also possible that when the board is almost filled, and it is becoming harder to enter more words, that the players have the option to switch one or more already entered words, to fit in a new, without getting any more points for that, alternatively getting points for everything new that is written. In this case there should be a limit for how many times the players are allowed to change a word, for example 1-2 times, not making is too simple.

Instead of letting the players enter words freely, there could beside the game board possibly be a list of subject categories which lets the player know within which subject the specific word is. A marker in the category column may automatically moves down along the list when the turn changes. The amount of categories in the list should be an uneven amount so a player will not receive the same category repeatedly.

It can also be as such, that the players each have their own identical board; visible to both and that they compete in who can fill in their board the quickest. In this version a word can only be used once, meaning that if player 1 enters a word on his board then player 2 cannot use the same word on his. In this case the look of the game board shall always be randomly selected so you are not able to repeatedly enter the same word. In general all versions of the game that are in the base game shall also be applied in this one.

It is also possible for a player to play the crossword puzzle alone. The timer is then on continuously and the player may fill in the answers. If the player cannot fill in all the words during the allocated time, the game is scored based on the number of correctly filled in words and the amount of time used.

There are many additional variations of the puzzle 10 of the present invention. It may also be possible to permit both players to have continuous access to the puzzle 10 so that the players may fill in as many words as possible within the time allocation 42. The player who first solves the puzzle 10 or has filled in the most correct words is the winner.

A variation is that each player may be allocated a certain time limit for each word such as 10 seconds per word. Two players take turn to answer as many questions as possible. When one player cannot add a correct word within the time allotted, such as 10 seconds, the turn goes to the opposing player. Each time a correct word/answer is provided, the timer may be set to 10 seconds. The player who has added most words to the puzzle has won.

Another variation is to let several players, such as 2-4 players, solve the same crossword for a time limit, such as 4 minutes, in parallel without seeing each others crossword. The player who has added the most correct words to the crossword puzzle has won.

A yet another variation is to let several player, such as 2-4 players, solve the same crossword in parallel without seeing each others crossword. The player who solves the entire crossword puzzle first is the winner.

Another variation is to let 2 players add a word every other time. A maximum time, such as 30 seconds, may be provided for each turn. This maximum time may be reduced by, for example, 2 seconds after each turn. Each player may be allocated a maximum time such as 8 minutes in total. The player who has added most correct words when the time is up or the player who has the most time left when the crossword puzzle is solved is the winner.

It may be possible to display a list of the players who have accumulated the most points from previous crossword puzzle games so that the players may be ranked. It is also possible to display of players who are seeking opponents. A player may simply select a player by clicking on the name of the player in the list. The game should be possible to be played as a tournament with either real or fake money. The game can also be played in a so called “TV-format.” The crossword puzzle of the present invention may also include questions in six different subjects in addition to add-on or transport questions. Similar to the basic principles described above, the players take turn in intervals of for example 90 seconds.

There may, for example, be three questions in each subject and they can have three different difficulty levels that generate 5 points for the easiest questions, 10 points for the questions at the intermediate difficulty level and 15 points for the most difficult level.

In the squares for the questions of a subject, the questions may be written in the square or the crossword puzzle similar to conventional crossword puzzles. In the alternative, only the number of points is shown in the square and the player will not know the question until the player has clicked on the square to display a window in which the question is shown. It is then possible to use longer and more complicated questions since there is enough room in the window. Also, there is an added excitement by not knowing the question but only the difficulty level of the subject matter prior to activating the question. In this version, the game board may possibly have the shape of racing track with six lanes, one for each subject and the players move around on this by answering questions. Easy questions mean a short movement and hard questions a longer one. Players are allowed to jump between the lanes (subjects) whenever they like. In some places the track narrows (sometimes down to one lane) and all players must then adapt to this. If a player is completely stuck, not being able to answer any question, he may use a lifeline and move in the slowest track. The questions on the track can be either open or hidden but in certain “very sharp corners” they shall always be hidden and if the players answer those questions correctly the players will move many steps. The winner is the one first across the finish line.

The add-on or additional transport questions preferably do not generate points but only serve to guide the player to make it easier to answer the question, as indicated above. When the word answer to an add-on question is filled in correctly, the timer may be changed so that the interval is shortened by, for example, 20 seconds and as long as correct answers are filled in the player may continue. For each correct answer the timer is re-started at 20 seconds. It is also possible to let the turn go over to the other player so that the first player does not take advantage of filling in an add-on question correctly. In other words, the first player may in this way help the other player solve the point generating question associated with the add-on questions.

The winner must have at least one correct answer in each subject matter or, when the time is up, has generated the most points. It is possible to set the points so that it is valued higher to have at least one correct answer in each subject matter.

It is also possible to hide a picture of a person, place, building etc. in the crossword puzzle. The questions in the crossword puzzle may relate to the hidden picture and by answering the questions the hidden picture is gradually displayed. The questions that make the outer edges of the hidden picture visible may be relatively easy while the more essential parts of the hidden picture are only made visible by correctly answering relatively difficult questions. It is also possible to divide the questions into different subject matters and my selecting a subject matter the player must continue with the same subject matter until the player answers incorrectly. During the game, a player may at any time guess what the picture displays and is the guess is correct the entire picture is displayed.

It is also possible to include, for example, 10 crossword puzzle of varying difficulty level. The first crossword may be relatively easy while the last crossword puzzle is very difficult. The crossword puzzles must be solved in sequence so that the first crossword puzzle must be solved before the player can gain access to the second crossword puzzle and so on. It is also possible to pause a crossword puzzle and continue solving it at a later time. The questions should be of a character such that a player cannot simply go a look them up in encyclopedias. The website may have a ranking list that keeps tracks of the number of players who have successfully solved a crossword puzzle at each level and the time required. This means the player who requires the least time is ranked the highest for each difficulty level of the crossword puzzles.

While the present invention has been described in accordance with preferred compositions and embodiments, it is to be understood that certain substitutions and alterations may be made thereto without departing from the spirit and scope of the following claims.

1. A method of solving a digital crossword puzzle, comprising:
providing a first player (16) and a second player (18); allocating a first time to the first player and a second time to the second player,
the first player activating a first timer (43) to solve a first question of the crossword puzzle,
the first player correctly adding a first word to the crossword puzzle,
the puzzle confirming (48) the first word being correct, the puzzle adding points to a score board (51) of the first player (16), and
the second player (18) activating a second timer (45) to solve a second word of the crossword puzzle.

2. The method according to claim 1 wherein the method further comprises requiring the first player (16) to recognize a word related to a sound bite (52).

3. The method according to claim 1 wherein the method further comprises requiring the first player (16) to recognize a word related to a video clip (54).

4. The method according to claim 1 wherein the method further comprises automatically filling in (56) all correct words when the first and/or second timers (43, 45) have expired.

5. The method according to claim 1 wherein the method further comprises preventing the first and second players from solving a crossword puzzle twice.

6. The method according to claim 1 wherein the method further comprises allocating a total time (42) to the crossword puzzle (10).

7. The method according to claim 1 wherein the method further comprises the first player (16) activating a pass button (46).

8. The method according to claim 1 wherein the method further comprises the first player (16) and the second player (18) being connected to a common website (40).

9. The method according to claim 1 wherein the method further comprises the player selecting a subject matter.

10. The method according to claim 9 wherein the method further comprises only obtaining points for a correct word related to the selected subject matter.

11. The method according to claim 1 wherein the game board is structured as a racing track and where the players move by answering questions of various difficulties.

12. The method according to claim 1 wherein the game is created in a TV-format.

13. The method according to claim 1 wherein the game board consists of randomly generated black and white boxes collected from a database and where the players, with technical support from a dictionary, in turns fill in their own words which must fit in with the words already entered.

14. The method according to claim 1 wherein the players have an option of switching between already written words to be able to fit in a new one.

15. The method according to claim 1 and 12 wherein the players must enter words within a certain subject category listed in a column beside the board.

16. The method according to claim 1 wherein the players each play on their own board, visible to them both, and where words, with technical support from a dictionary, are only allowed to be entered once.
